(19) United States
(12) Patent Application Publication
(10) Pub. No.: US 2012/0138361 A1
(43) Pub. Date: Jun. 7, 2012

(54) Cable Terminator Assemblies

(75) Inventor: Howard Elliott, Oxfordshire (GB)

(73) Assignee: FUTURE TECHNOLOGY (SENSORS) LTD., Oxfordshire (GB)

(21) Appl. No.: 13/308,866

(22) Filed: Dec. 1, 2011

(30) Foreign Application Priority Data
Dec. 3, 2010 (EP) 10015283.4

(51) Int. Cl. H01R 9/05

(52) U.S. Cl. 174/74 R

(57) ABSTRACT

The invention relates to a cable terminator assembly that can be used with a transmission cable such as a coaxial or triaxial cable, for example. Such a transmission cable can have an inner conductor and an outer conductor or shield. The cable terminator assembly includes an electrically conductive inner locator body or pin that includes a passageway for receiving the inner conductor. The passageway is brazed to the inner conductor to provide an electrical connection and a hermetic seal. An electrically conductive outer body is adapted to be brazed to the outer conductor to provide an earth connection and a hermetic seal. An intermediate spacer body of electrically insulating material (e.g. ceramic) is located between the inner locator body and the outer body.

### CROSS REFERENCE TO RELATED APPLICATION

This application claims priority to earlier filed European Patent Application No. 10015283.4, filed on Dec. 3, 2010, which is incorporated herein in its entirety by reference.

### FIELD

The present invention relates to cable terminator assemblies, and in particular to cable terminator assemblies that can be used to provide a solid and reliable termination to an electrical cable such as a conventional coaxial or triaxial cable. In one possible arrangement the cable terminator assembly is constructed so that it is particularly suitable for use in high temperature operating environments.

### BACKGROUND

A conventional coaxial cable includes an inner conductor or center core surrounded by an outer conductor in the form of tubular shield. The inner and outer conductors are separated by an insulating layer. A conventional triaxial cable includes an additional tubular intermediate conductor that is separated from the inner and outer conductors by insulating layers.

Coaxial and triaxial cables often need to be provided with a reliable termination means which optionally may enable the cable to be easily connected to an external device.

### SUMMARY

The present invention provides an improved cable terminator assembly for use with an electrical cable having a first conductor (e.g. an inner conductor or center core of a coaxial or triaxial cable) and a second conductor (e.g. an outer conductor or tubular shield of a coaxial or triaxial cable or the intermediate conductor of a triaxial cable), the cable terminator assembly comprising: an electrically conductive inner locator body having a passage for receiving the first conductor of the cable; an electrically conductive outer body adapted to be secured to the second conductor; and an electrically insulating intermediate spacer body (i.e. formed at least in part from a dielectric or electrically non-conductive material) located between the inner locator body and the outer body.

As described in more detail below, the cable terminator assembly provides a means of hermetically sealing an end of the electrical cable and supports the cable conductors.

An end portion of the inner locator body is preferably adapted to be received in a recess provided in an external device or connector, e.g. a sensor assembly or a further cable assembly having corresponding mating features. In other words the end portion may be sized and shaped to facilitate easy connection of the cable terminator assembly to the external device or connector. This is particularly important in high temperature applications where a high temperature cable may be connected to another type of cable which operates in a lower temperature region. The cable terminator assembly may therefore allow different types of cables to be connected together in a way that increases performance and reduces cost. The cable terminator assembly may be releasably or permanently secured to the external device or connector by any suitable means, preferably so that a reliable electrical connection is provided. For example the end portion of the inner locator body may be welded or brazed to the external device or connector, or the cable terminator assembly may be connected by suitable mating features or by means of a screw thread provided on the inner locator body or the outer body with a corresponding screw thread being provided on the external device or connector.

In the case of a sensor assembly then the end of the cable which interfaces with the sensor assembly is typically cut to size and the exposed cable conductors are connected to the appropriate sensor connectors by a conventional welding or brazing process. This means that if the sensor assembly is non-hermetic then moisture can enter the cable through the sensor assembly resulting in a potential shift in the calibration of the sensor assembly and a corresponding loss in performance. By providing a hermetic seal the cable terminator assembly therefore maximizes sensor performance by eliminating any calibration drift resulting from the ingress of moisture. Most mineral-insulated cables are hygroscopic and so a cable that has been cut to length before it is connected to the sensor assembly will quickly absorb moisture unless it is stored in an appropriate environment. By connecting the cable to the cable terminator assembly as soon as it has been cut to length then the cable can be stored in normal ambient conditions before it is connected to the sensor assembly. The hermetic seal also prevents calibration drift resulting from the breakdown of isolation resistance between the cable conductors caused by oxidation at relatively low temperatures. Such oxidation of the cable conductors can eventually lead to a complete breakdown of the electrical properties of the cable.

The cable terminator assembly supports the cable conductors and minimizes the risk of damage or failure caused by vibration and/or thermal expansion.

The construction of the cable terminator assembly preferably ensures that any cable insulation that may become detached during use is retained within the cable or the cable assembly and does not enter the sensor assembly.

The intermediate spacer body can be substantially cylindrical and have an inner surface that is secured to the inner locator body and an outer surface that is secured to the outer body. The intermediate spacer body provides an insulating layer between the inner locator body and the outer body which essentially replicates the insulating layer(s) provided between the cable conductors.

The cable terminator assembly may have a coaxial arrangement that can be used with either coaxial or triaxial cables. In the coaxial arrangement the inner conductor or center core is received in the passage of the inner locator body and the outer body is secured to the outer conductor or tubular shield to provide an earth connection. In the case where the cable termination assembly is connected to a triaxial cable then the intermediate conductor will normally abut the intermediate spacer body and there is no electrical connection between the intermediate conductor and the cable terminator assembly.

For the reasons discussed above, the outer body is preferably secured to the outer conductor to provide a hermetic seal and the inner locator body is preferably secured to the inner conductor to provide a hermetic seal, e.g. by means of a hermetic weld or braze. In practice the inner locator body may be secured to the inner conductor by a spot weld or braze at or about its end portion.

The cable terminator assembly may alternatively have a triaxial arrangement that can be used with triaxial cables. In this arrangement the cable terminator assembly preferably further includes an electrically conductive second outer body adapted to be secured to a third conductor of the cable (e.g. the outer conductor or tubular shield of a triaxial cable) and a second electrically insulating intermediate spacer body located between the second outer body and the outer body. The second intermediate spacer body can be substantially cylindrical and have an inner surface that is secured to the outer body and an outer surface that is secured to the second outer body. The second intermediate spacer body provides an insulating layer between the outer body and the second outer body. The outer body may have a first part that lies radially outside the intermediate spacer body and a second part that lies radially inside the second intermediate spacer body for a compact construction.

In the triaxial arrangement the inner conductor or center core is received in the passage of the inner locator body, the outer body is secured to the intermediate conductor, and the second outer body is secured to the outer conductor or tubular shield to provide an earth connection.

For the reasons discussed above, the second outer body is preferably secured to the outer conductor to provide a hermetic seal, the outer body is preferably secured to the intermediate conductor to provide a hermetic seal, and the inner locator body is preferably secured to the inner conductor to provide a hermetic seal, e.g. by means of a hermetic weld or braze. Again, in practice the inner locator body may be secured to the inner conductor by a spot weld or braze at or about its end portion.

The cable terminator assembly can be formed from any suitable materials depending on the type of cable and the intended operating conditions. For example, the components that are electrically conductive can be made of metal or metal alloy (e.g. Kovar®, a nickel-cobalt ferrous alloy supplied by Carpenter Technology Corporation and which has expansion characteristics that match alumina ceramics and is suitable for intended operating temperatures of less than about 500° C., or for higher operating temperatures, a suitable oxide-resistant superalloy) or an electrically conductive ceramic material. The components that are electrically insulating can be made of ceramic materials such as aluminium oxide or silicon nitride or plastics materials. Constructions using metal and ceramic components secured together using conventional brazing techniques are expected to be capable of operating at temperatures up to 800° C. but higher temperatures may be achieved for other constructions.

The method for securing or bonding the components together will depend on the type of materials used. For example, metal or metal alloy and ceramic components can be brazed or welded together but for low temperature operations then conventional adhesives or electrically conductive adhesives may be used. It will be readily appreciated that any suitable methods or processes for securing the components together can be used. Similarly, any suitable methods or processes can be used to secure the cable terminator assembly to the cable conductors.

Although the cable terminator assembly will typically be used with a coaxial or triaxial cable of conventional construction, it will be readily appreciated that it may also be used with other cable types having any compatible conductor configuration. A cable terminator assembly may be used to hermetically seal one or both ends of the cable. If only one cable terminator assembly is used then the other end of the cable may be optionally hermetically sealed to a different type of connector.

### BRIEF DESCRIPTION OF THE DRAWINGS

FIG. 1 is a cross section view through a coaxial cable terminator assembly according to the present invention;

FIG. 2 is a cross section view showing how the coaxial cable terminator assembly of FIG. 1 is connected to a coaxial cable;

FIG. 3 is a cross section view showing how the coaxial cable terminator assembly of FIG. 1 is connected to a triaxial cable;

FIG. 4 is a cross section view through a triaxial cable terminator assembly according to the present invention; and

FIG. 5 is a cross section view showing how the triaxial cable terminator assembly of FIG. 1 is connected to a triaxial cable.

### DETAILED DESCRIPTION OF THE EMBODIMENTS

Embodiments of the present invention will now be described by way of example only and with reference to the accompanying drawings.

With reference to FIG. 1 a cable terminator assembly 1 having a coaxial construction includes a substantially cylindrical metal outer body 2. A cylindrical ceramic spacer or bush 4 is brazed to a front part of the inner surface of the outer body 2. A rear part of the outer body 2 defines an open recess 6 for receiving a coaxial or triaxial cable as described in more detail below. A locator body or pin 8 is brazed inside the ceramic spacer 4 and includes a radially-extending flange 10 that abuts an annular end surface of the ceramic spacer. The flange 10 makes the locator body 8 self-jigging during brazing and also provides an interface feature to a sensor or cable assembly for welding purposes. A front portion 12 of the locator body 8 is adapted to be received in a recess (not shown) provided in a sensor assembly (not shown) such as a sensor that can be used at high operating temperatures to measure the distance to either a stationary or passing object, typically for the measurement of clearance between the tip of a gas turbine engine blade and the surrounding casing. When the cable terminator assembly 1 is connected to the sensor assembly (not shown) an electrical connection is provided between the inner conductor of the cable and the sensor assembly, either directly or by means of the electrically conductive locator body 8.

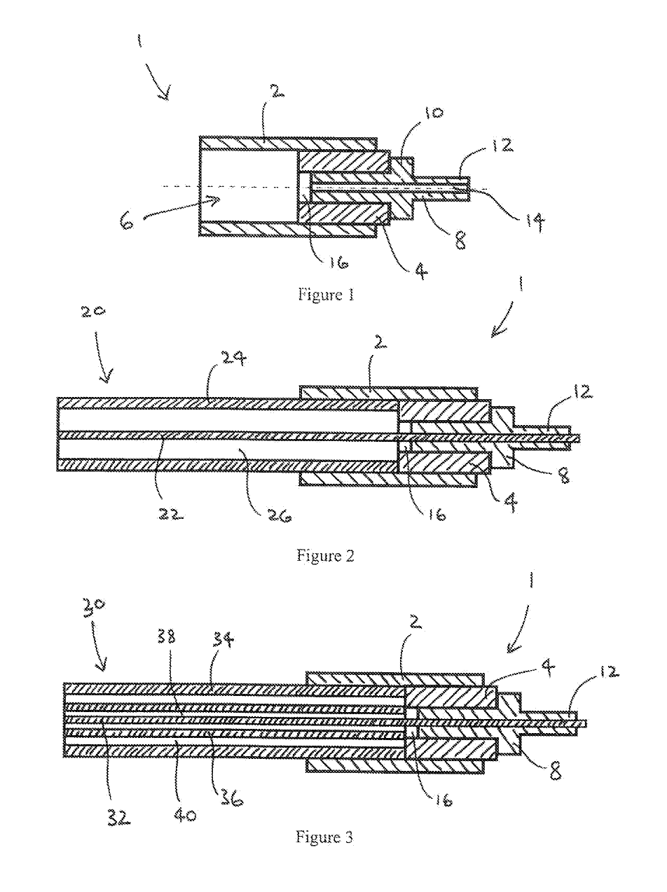

The coaxial cable terminator assembly 1 can be used to terminate a coaxial cable 20 as shown in FIG. 2. The coaxial cable includes an inner conductor or center core 22 and an outer conductor 24 in the form of a tubular shield. The inner and outer conductors are separated by an insulating layer 26. The outer body 2 is brazed to the outer conductor 24 to provide an earth connection and a hermetic seal that prevents the ingress of moisture into the recess 6. The inner conductor 22 passes through a passageway 14 in the locator body 8. The front portion 12 of the locator body 8 is welded or brazed to the inner conductor 22 to provide an electrical connection and a hermetic seal that prevents the ingress of moisture into the passageway 14. Electrical signals provided by the sensor assembly (not shown) are transmitted along the inner conductor 22.

The coaxial cable terminator assembly 1 can also be used to terminate a triaxial cable 30 as shown in FIG. 3. The triaxial cable includes an inner conductor or center core 32, an outer conductor 34 in the form of a tubular shield, and an intermediate conductor 36. The inner and intermediate conductors are separated by a first insulating layer 38 and the intermediate and outer conductors are separated by a second insulating layer 40. The outer body 2 is brazed to the outer conductor 34 to provide an earth connection and a hermetic seal that prevents the ingress of moisture into the recess 6. The inner conductor 32 passes through a passageway 14 in the locator body 8. The front portion 12 of the locator body 8 is welded or brazed to the inner conductor 32 to provide an electrical connection and a hermetic seal that prevents the ingress of moisture into the passageway 14. There is no electrical connection with the intermediate conductor 36. A recess 16 is provided at the rear of the locator body 8 to assist in the welding or brazing process and to prevent the intermediate conductor 36 from coming into contact with the rear face of the locator body.

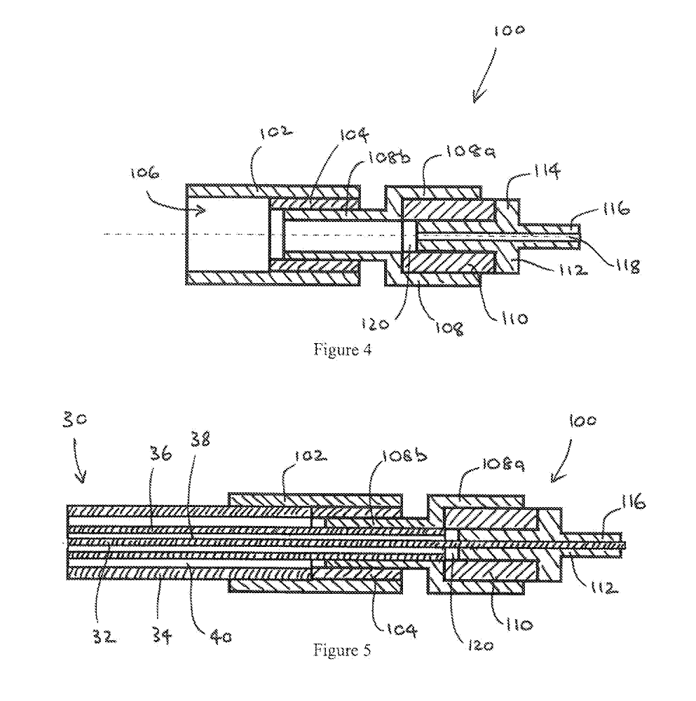

With reference to FIG. 4 an alternative cable terminator assembly 100 having a triaxial construction includes a substantially cylindrical metal rear outer body 102. A cylindrical rear ceramic spacer or bush 104 is brazed to a front part of the inner surface of the rear outer body 102. A rear part of the rear outer body 102 defines an open recess 106 for receiving a triaxial cable 30 as described in more detail below. A front outer body 108 has a stepped profile with a front part 108a and a rear part 108b that defines a narrower recess for receiving the intermediate conductor 36 of the triaxial cable 30. The rear part 108b is brazed inside the rear ceramic spacer 104. A cylindrical front ceramic spacer or bush 110 is brazed inside the front part 108a of the front outer body 108. A locator body or pin 112 is brazed inside the front ceramic spacer 110 and includes a radially-extending flange 114 that abuts an annular end surface of the front ceramic spacer. The flange 114 makes the locator body 112 self-jigging during brazing and also provides an interface feature to a sensor or cable assembly for welding purposes. A front portion 116 of the locator body 112 is adapted to be received in a recess (not shown) provided in a sensor assembly (not shown).

The triaxial cable terminator assembly 100 can also be used to terminate a triaxial cable 30 as shown in FIG. 5. The rear outer body 102 is brazed to the outer conductor 34 to provide an earth connection and a hermetic seal that prevents the ingress of moisture into the recess 106. The inner conductor 32 passes through a passageway 118 in the locator body 112. The front portion 116 of the locator body 112 is brazed to the inner conductor 32 to provide an electrical connection and a hermetic seal that prevents the ingress of moisture into the passageway 118. The rear part 108b of the front outer body is welded or brazed to the intermediate conductor 36. A recess 120 is provided at the rear of the locator body 112 to assist in the welding or brazing process and to prevent the intermediate conductor 36 from coming into contact with the rear face of the locator body.

What is claimed is:

1. A cable terminator assembly for use with an electrical cable having a first conductor and a second conductor, the cable terminator assembly comprising:
an electrically conductive inner locator body having a passage for receiving the first conductor of the cable;
a first electrically conductive outer body adapted to be secured to the second conductor; and
a first electrically insulating intermediate spacer body located between the inner locator body and the first outer body.

2. The cable terminator assembly of claim 1, wherein the intermediate spacer body is substantially cylindrical and has an inner surface that is secured to the inner locator body, and an outer surface that is secured to the first outer body.

3. The cable terminator assembly of claim 1, wherein the inner locator body includes an end portion that is adapted to be received in a recess provided in an external device.

4. The cable terminator assembly of claim 1, further comprising a second electrically conductive outer body adapted to be secured to a third conductor of the cable, and a second electrically insulating intermediate spacer body located between the second outer body and the first outer body.

5. The cable terminator assembly of claim 4, wherein the second intermediate spacer body is substantially cylindrical and has an inner surface that is secured to the first outer body, and an outer surface that is secured to the second outer body.

6. The combination of:
a coaxial cable having an inner conductor and an outer conductor; and
a cable terminator assembly comprising:
an electrically conductive inner locator body having a passage for receiving the first conductor of the cable;
an electrically conductive outer body adapted to be secured to the second conductor; and
an electrically insulating intermediate spacer body located between the inner locator body and the outer body;
wherein the inner conductor is received in the passage of the inner locator body and the outer body is secured to the outer conductor.

7. The combination of claim 6, wherein the outer body is secured to the outer conductor to provide a hermetic seal.

8. The combination of claim 6, wherein at least an end portion of the inner locator body is secured to the inner conductor to provide a hermetic seal.

9. The combination of claim 6, wherein the cable terminator assembly is secured to the cable conductors by welding or brazing.

10. The combination of:
a triaxial cable having an inner conductor, an outer conductor, and an intermediate conductor; and
a cable terminator assembly comprising:
an electrically conductive inner locator body having a passage for receiving the first conductor of the cable;
a first electrically conductive outer body adapted to be secured to the second conductor; and
a first electrically insulating intermediate spacer body located between the inner locator body and the first outer body;
wherein the inner conductor is received in the passage of the inner locator body, and the first outer body is secured to the outer conductor.

11. The combination of claim 10, wherein the first outer body is secured to the outer conductor to provide a hermetic seal.

11. The combination of claim 10, wherein at least an end portion of the inner locator body is secured to the inner conductor to provide a hermetic seal.

12. The combination of claim 10, wherein the cable terminator assembly is secured to the cable conductors by welding or brazing.

13. The combination of:
a triaxial cable having an inner conductor, an outer conductor, and an intermediate conductor; and
a cable terminator assembly comprising:
an electrically conductive inner locator body having a passage for receiving the first conductor of the cable;
a first electrically conductive outer body adapted to be secured to the second conductor;
a first electrically insulating intermediate spacer body located between the inner locator body and the first outer body;
a second electrically conductive outer body adapted to be secured to a third conductor of the cable; and
a second electrically insulating intermediate spacer body located between the second outer body and the first outer body;
wherein the inner conductor is received in the passage of the inner locator body, the first outer body is secured to the intermediate conductor, and the second outer body is secured to the outer conductor.

14. The combination of claim 13, wherein the second intermediate spacer body is substantially cylindrical and has an inner surface that is secured to the first outer body, and an outer surface that is secured to the second outer body.

15. The combination of claim 13, wherein the first outer body is secured to the intermediate conductor to provide a hermetic seal.

16. The combination of claim 13, wherein the second outer body is secured to the outer conductor to provide a hermetic seal.

17. The combination of claim 13, wherein at least an end portion of the inner locator body is secured to the inner conductor to provide a hermetic seal.

18. The combination of claim 13, wherein the cable terminator assembly is secured to the cable conductors by welding or brazing.
